(19) United States
(12) Patent Application Publication
(10) Pub. No.: US 2023/0345934 A1
(43) Pub. Date: Nov. 2, 2023

(54) Solid Composite Matrix for Prolonged Delivery of Active Agents

(71) Applicant: AB7 SANTE, DEYME (FR)

(72) Inventors: Montaine LONGATO, Fronton (FR); Arnaud VILBERT, BAZIEGE (FR); David NGUYEN, Toulouse (FR)

(21) Appl. No.: 17/799,517

(22) PCT Filed: Feb. 12, 2021
(86) PCT No.: PCT/FR2021/000015

§ 371 Date: Aug. 12, 2022

(30) Foreign Application Priority Data
Feb. 14, 2020 (FR) 2001462

(51) Int. Cl. A01P 17/00; A01P 19/00; A01N 25/10; A01N 25/34

(52) U.S. Cl. CPC A01N 25/10; A01N 25/34; A01P 17/00; A01P 19/00

(57) ABSTRACT

The invention relates to a composite polymer matrix carrier for prolonged delivery of active substances suitable for controlled release over a sustained period of time. More particularly, the invention relates to a composite polymer matrix carrier comprising at least one thermoplastic polymer, at least one cellulose derivative, and at least one active agent, and the method for manufacturing same. The invention also relates to the use of a cellulose derivative for improving the incorporation of active agents in a thermoplastic polymer matrix.

The invention is in the field of thermoplastic-based solid polymer carriers, and more precisely the incorporation of active substances within a composite solid structure that serves a carrier, in order to allow for the progressive and controlled release thereof in a surrounding medium.

The invention thus relates to a composite polymer matrix carrier for prolonged delivery of active substances suitable for controlled release over a sustained period of time. More particularly, the invention relates to a composite polymer matrix carrier comprising at least one thermoplastic polymer, at least one cellulose derivative, and at least one active agent.

Another object of the present invention also relates to a method for manufacturing a carrier of this kind. The polymer carrier is a solid polymer matrix based on thermoplastic, which functions as a reservoir for active agent(s). Said function is achieved by virtue of a method which makes it possible to add an active agent vector into a thermoplastic polymer during an incorporation step, and to thus obtain, as a final product, a composite matrix comprising at least one thermoplastic polymer and at least one cellulose derivative, laden with active agents.

The methods conventionally used in plastics manufacturing include the extrusion methods and the injection-molding methods. It should be understood that the new method of the present application favors injection-molding, but without excluding the possibility of extrusion.

The use of thermoplastics has many and various applications; these include plastics manufacturing methods used in the manufacture of veterinary products or products intended for humans.

Nowadays, the treatment of pets takes place via two main paths. On the one hand, liquid formulations of the emulsion, solution or dispersion type exist, inter alia in the form of “spot-on,” “roll-on,” shampoo, lotion, or indeed sprays, which consist in the topical application of a substance to the animal, and on the other hand the range of spontaneous diffusion treatments, having long-term effectiveness, via active agents contained in a solid carrier, also exist. Said carrier can be made into the form of a collar, a tag, an animal ear tag, a strap, a patch, a pad, a block polymer, or any other device for distributing active agents. It is shaped by any of the techniques of the plastics manufacturing industry that are known to a person skilled in the art.

The plastics materials for the diffusion of active agents, as well as the methods for incorporating active agents into said materials are known from the prior art. The prior art in particular describes matrices of polyurethane (PU), ethylene vinyl acetate (EVA), polyvinyl chloride (PVC), and some polyesters for which the incorporation of active agents is the subject of numerous investigations. Indeed, of the plastics materials permitted in the diffusion of active agents in humans or animals, and in particular in antiparasitic treatment, the plastics materials belonging to the class of the EVAs or PVC are favored. However, no incorporation technique using cellulose derivatives as an active agent carrier has been used, to date, in a plastics materials matrix.

The prior art also relates to PU matrices and, with respect to this example, the document FR2992325 can be cited, which discloses a polyurethane matrix within which an active agent is incorporated. Furthermore, the documents FR2386254A1 and US4189467 disclose, respectively, anti-ectoparasite collars, and PU matrices having the same effect. However, these documents neither disclose nor suggest a method in which active agents are incorporated into a cellulose derivative.

In its commercial application, polyethylene (PE), in turn, has an intended use mainly in packaging (plastics bottles, etc.) and other plastics bags as conventionally known. On account of its physicochemical properties, and its relative impermeability to voluminous active agents, PE is a polymer which is little used in the field of controlled release of active agents. This can be explained in part by the fact that PE is the polymer having the simplest possible structure, based on chain formation of units of —CH2—. There are a plurality of types of PE, including LDPE (low-density polyethylene) or HDPE (high-density polyethylene), having different degrees of crystallinity. Polyethylene is found, in its high-molecular weight variants (HDPE), in the fiber of technical textiles such as sports equipment (sails, kites, anti-abrasion combination for motorcycles). LDPE, in turn, has a low degree of crystallinity, and the structure thereof comprises a significant number of amorphous zones, which can in theory incorporate active molecules. However, within LDPE, these can receive only small molecules in a very low quantity. Nonetheless, there are some examples of such materials used in the fields of application such as active packaging, medical devices, and active textiles.

Thus, active packaging of PE allowing for the diffusion of antioxidant molecules has already been the subject of numerous studies. Indeed, despite the very good humidity barrier properties, PE is not particularly oxygen-proof, and only partially protects the food from oxidation. Active packagings have therefore been formed comprising synthetic molecules such as BHT (butylated hydroxytoluene), or natural extracts such as astaxanthin, carvacrol or thymol. The release of perfumes or aromas has also been investigated, in particular using vanillin incorporated in a LDPE film.

The article “Permeability and release properties of cyclodextrin-containing poly (vinyl chloride) and polyethylene films, (2007)” shows that active agents are released progressively from the plastics films but, for the most sensitive molecules, the use of cyclodextrin is necessary in order to protect them from the degradation caused by the usage temperatures, which may reach 200° C. Moreover, said active agents are introduced into the films at very low rates (<2% of the total weight).

Furthermore, within the context of devices that progressively release active substances for medical purposes, implants for animals exist which are based on polyethylene, incorporating progesterone. These make it possible to release the molecule over several weeks, at very low levels, of the order of a milligram per day. In this case, the polyethylene is used mainly for its properties of mechanical rigidity. The active agent is incorporated into the polyethylene via granulation by twin-screw extrusion, at a temperature of close to 200° C. This step is repeated several times in order to ensure good homogenization of the medicine within the matrix. Finally, the devices are obtained by injection.

The use of PE in the thermoplastics which incorporate active materials is therefore rare, in particular due to the fact that the incorporation of such substances is not as easy in PE as within EVA or PU matrices for example. Indeed, it is difficult to sus-tainably incorporate an active agent in a sufficient quantity, and to stabilize it within a PE matrix. It is known that the active agent to be incorporated tends to be salted-out immediately, not remaining within the polymer matrix. However, the aim of the matrix according to the invention is that of incorporating the active agent in a stable manner, and of salting it out in a controlled manner over time. Moreover, since the incorporation methods mostly require high temperatures, they are not suitable for the use of temperature-sensitive active agents.

Another current trend consists in limiting the use of plastics material, leaving the door open for innovation on more or less environmentally friendly products. These latter products are above all developed in part using material of natural origin, such as wood derivatives, or cellulose derivatives.

Regarding the use of cellulose derivatives in PE, the application US4559365 discloses an approach for improving the dispersibility of the cellulose in a material. More particularly, this document relates to a hydrolytic pre-treatment of the cellulose in order to convert this into a microcrystalline powder having improved dispersibility in high-density polyethylene. This document makes no statement regarding the incorporation of an active agent within the material, and therefore regarding any action of the cellulose derivative on the vectorization or the incorporation of an active agent within the polymer matrix.

Cellulose fiber has also been used as a reinforcement ingredient in thermoplastic compositions. The application US 3 856 724 describes a composite based on polypropylene or low-density polyethylene, and alpha cellulose, with some additives. The application US 3875088 describes a composite material comprising a thermoplastic resin binder (ABS or rubber-modified polystyrene), and wood flour, the plastics/wood flour ratio being between 1.5 and 3.0. The application US 3878143 describes a composite material comprising polyvinyl chloride, polystyrene, or ABS, and wood flour, as well as some minor additives. The application WO2018/169904 describes a composite material comprising only a lignocellulosic derivative of wood origin, within a thermoplastic matrix, so as to reinforce the matrix. All these documents mention the use of cellulose derivatives in the sole aim of improving the resistance of thermoplastic materials which are too fragile in the disclosed cases. However, none of these documents discloses or suggests the use of cellulose derivatives which can contain active agents, or their use in the aim of vectorizing the active agent, or of improving the incorporation of said active agents within thermoplastics.

The document US5516472 in turn discloses a composite made up of approximately 26% high-density polyethylene and 65% wood flour, the entire product being extruded in the presence of zinc stearate as a lubricating agent. Once again, there is no mention of active agents in this document.

The U.S. Pat. No. 6,758,996 relates to a granular material made from a composite which could be of polyethylene. Said patent discloses a composite material which comprises a mixture of paper mill sludges in the form of granules, and a synthetic polymer resin composition. Said granules may be used as the main ingredient in the formulation of thermoplastic composite materials. The thermoplastic composite granules of said application are made up of 60 to 75 wt.% cellulose fibers, 20 to 40 wt. % plastics polymers (e.g. LDPE, HDPE, polypropylene, PVC, polyamide) and additives (colorants, compatibilizing agents, fireproof agents, etc.). The composite granules may be extruded, injected, or compression molded. This patent therefore shows that paper mill sludges in the form of granules mixed into a thermoplastic polymer increase the flexural strength as well as the deformation resistance of the composite, while making it possible to reduce the risks of fire and moisture intake. In no case does this patent suggest the use of cellulose derivatives for promoting the incorporation of active agents in a polymer matrix.

The U.S. Pat. No. 5,248,700 discloses a polymer matrix system, within which different active materials, at different concentrations, can be incorporated simultaneously. In order to achieve this, the active material is first incorporated in a microporous polymer powder in order to form the active agent, and then said active agent is subsequently dispersed within a biodegradable polymer. The biodegradable polymer is a polylactic acid, and the active agent is incorporated in a microporous powder of a polylactic acid which degrades less quickly than the biodegradable polymer. The active agents used in this application may be pesticides, medicines, fertilizers, or indeed perfumes, but nowhere is incorporation of an active agent in the polyethylene, and even less the use of cellulose derivatives, proposed.

The patent WO2013038426 describes a method for incorporating insecticides of the pyrethroid type in PE (HDPE, LLDPE, LDPE, PP). The incorporation is performed by “hot-melt.” The insecticide, in powder form, is mixed with the PE powder, then the compound is extruded in the form of strands intended for the manufacture of clothing. This document nowhere discloses a use of cellulose powder as a vector during the incorporation of active agents.

Active agent vectors are also known which have the function of storing the active agent and promoting its migration within the polymer matrix to be incorporated. This requires a good compatibility between the vector and the polymer matrix. The active agent vectors are generally selected from mineral fillers, such as triphenyl phosphate. It should be noted that some fillers may weaken or modify the physical characteristics of the polymer matrix. In the case where coalescence is sought for the transfer of the active agent into the carrier polymer, EP0537998 B1 uses, as a vector, an ether, polyethylene glycol or alkoxylated polyethylene glycol, a polypropylene glycol, polyethylene glycol/polypropylene glycol sequenced polymer, an ethoxylated alkyl phenol, or indeed a fatty ester, ethoxylated sorbitan. In the same way, in the French patent FR 2746261 B1 polyisocyanates were used as active agent vectors. However, the products which function by coalescence have the disadvantage of being highly unstable during storage. These patents make no mention of the use of cellulose derivatives as active agent vectors.

In view of the various documents cited above, the prior art contains little information on the incorporation of active agents in a thermoplastic matrix by means of a cellulose powder. At the most, the cellulose derivatives of the prior art are used, in most of the cited documents, for developing composite material, the mechanical resistance and the hardness of which is improved. They do not relate to an active matrix. Furthermore, the prior art documents which mention the incorporation of active agents within a PE film do not comprise any cellulose derivative. The prior art also mentions the difficulty of incorporating said active agents, present in generally low concentrations, i.e. less than or equal to a total of 2 wt.%.

There is therefore a need to provide a composite matrix based on thermoplastic, having incorporation of active agent in a sufficient amount, more than 2%, so as to achieve a sought effectiveness, while maintaining the stability of the composition, and which, optionally, allows the controlled release of said active agent over time.

Wishing to overcome a problem which has been hitherto unresolved, the applicant also intends, by way of the present application, to propose, for the first time, a thermoplastic matrix and a method for producing a matrix of this kind, which makes it possible to conceive of an incorporation of active agents by virtue of the particular use of a powder of at least one cellulose derivative, the detailed description of which will emerge from reading the following.

Within the meaning of the invention, a “matrix” refers to a solid carrier which can integrate or incorporate an active agent or an active agent vector. In the remainder of the application, the terms matrix, polymeric matrix, polymer matrix, composite matrix, composite polymer matrix, solid matrix, thermoplastic matrix, are used interchangeably in order to define the solid composite polymer carrier according to the invention.

One of the aims of the invention is that of providing a material that is capable of responding to the problem of the incorporation of active agents, optionally to the prolonged release in a thermoplastic matrix. Surprisingly, the applicant has found that the incorporation of active agents in a thermoplastic could be greatly improved by the addition of at least one cellulose derivative and the use of a new method for producing the solid composite matrix.

Consequently, a first object of the present invention consists in a composite matrix comprising at least one thermoplastic, at least one cellulose derivative, and at least one active agent. Said active agent is incorporated in the cellulose derivative, thus serving as the vector, in order to form the thermoplastic and cellulose derivative mixture laden with active agent, intended to be shaped by a plastics manufacturing method.

Within the meaning of the invention, “vector” means the fact that one compound may contain another, and transport it.

Another object of the invention is that of proposing a use of at least one cellulose derivative for allowing the incorporation of active agents within a non-incorporating thermoplastic matrix, and/or for improving the incorporation of active agents within a thermoplastic matrix, and/or for increasing the quantities of active agents which can be incorporated within said matrix.

According to the present invention, and according to a first variant, the polymers which make up the solid matrix are selected from the non-biodegradable thermoplastic polymers, selected from the group consisting of the polyolefins and their derivatives selected from the polyethylenes (PE), the polypropylenes (PP), the copolymers of ethylene vinyl acetate (EVA), the ethylene butyl acrylates, the polyamides, the copolyamides and their derivatives selected from the ether block amides (EBA), the polyvinyl chlorides (PVC), the thermoplastic polyurethanes (TPU), the styrenes and their derivatives selected from the polystyrene-poly(ethylene-butylene)-polystyrene (SEBS) copolymers, the polystyrene-polyisoprene-polystyrene (SIS) copolymers, the polystyrene-polybutadiene-polystyrene (SBS) copolymers.

According to a second variant of the present invention, the polymer which makes up the solid matrix is a biosourced and/or biodegradable thermoplastic polymer which may be a polyester or copolyester, selected from the polycaprolactones, the polyhy-droxyalkanoates, the polylactides (PLA), the polyester amides, the aliphatic and aromatic copolyesters, or an agropolymer selected from the polysaccharides, starch and the derivatives thereof, the cellulose esters, milk protein derivatives, or a mixture of all these polymers. “Biosourced” means a polymer originating from renewable, vegetable, animal, residual or algal resources. “Biodegradable” means polymers which degrade by virtue of living organisms, such as bacteria, fungi, algae. Some polymers may exhibit both characteristics, biosourced and biodegradable.

Preferably, and according to a first variant, the thermoplastics which make up the composite matrix are selected from the polyolefins, more particularly from the family of the polyethylenes (PE), i.e. the low-density polyethylenes (LDPE) and high-density polyethylene (HDPE), which a person skilled in the art is capable of distinguishing.

Advantageously, the low-density polyethylenes are preferred (LDPE), these, on account of their physicochemical structure, making it possible to obtain a more branched polymer network, and thus to leave spacer regions for the incorporation of possible active agents. In one embodiment, the thermoplastics may be a mixture of low-density and high-density polyethylene, in order to provide mechanical properties which can be adjusted according to the needs of a person skilled in the art.

In a second variant according to the invention, the thermoplastics which make up the matrix are biodegradable, polyester or copolyester, or biosourced, originating from milk proteins.

In a third variant according to the invention, the thermoplastics which make up the matrix consist of copolymers of ethylene vinyl acetate (EVA).

In the matrix according to the invention, the thermoplastic polymer is present in a sufficient quantity for reaching 100 wt.% of the total weight of the matrix.

Preferably, the thermoplastic which makes up the matrix according to the invention is free of any hydrosoluble thermoplastic polymer. Indeed, in one of the preferred embodiments, the matrix according to the invention is used in forming collars, straps or other devices intended to be placed on the animal or any other subject to be treated, and thus needs to not be soluble in water. Progressive disintegration of the matrix according to the invention could disrupt the diffusion kinetics of the active agents incorporated, which is not desirable according to the present invention.

The cellulose derivatives of lignocellulosic origin are known for the development of composite materials, because they greatly increase the resistance, but also the hardness, of the final product, when “raw” cellulose is in particular in the form of wood sawdust. Said hardness is not desirable for forming products according to the invention, which requires mechanical resistance but also flexibility. Furthermore, these lignocellulosic compounds exhibit a low incorporation capacity and a low cohesion with the polymers, which may have a negative impact on the cohesion of the composite matrix according to the invention. One of the objects of the present invention is therefore that of selecting cellulose derivatives, said derivatives being selected so as to be different from raw cellulose or lignocellulosic derivatives, in order not to increase the hardness of the matrix, and to improve the incorporation of active agents within a stable thermoplastic matrix.

Surprisingly, the applicant has been able to develop a composite matrix and a particular method which overcome the problems of hardness of the final composite material and make it possible to improve the incorporation of active agents within the thermoplastic matrix.

Indeed, in the present application the choice is made to use chemically pure cellulose derivatives, in powder form or in the form of granules, and not sawdust and microfi-brils. In this way, a final material is obtained which is satisfactory both in terms of flexibility and in terms of its mechanical resistance. Within the meaning of the invention, “cellulose derivative” means the result of chemical treatment of the natural fiber of “raw” cellulose. “Chemically pure derivative” means a cellulose derivative powder where the compound is present in an amount of at least 95%.

The cellulose derivatives according to the invention are selected from the cellulose esters, the cellulose ethers, or a mixture thereof. The cellulose esters are selected from cellulose acetate (CA), cellulose triacetate (3CA), cellulose butyrate (BuC), cellulose propionate (ProC), cellulose acetobutyrate (AceBuC) or cellulose acetopropio-nate (AceProC). The cellulose ethers are selected from methylcellulose (MC), ethylcellulose (EC), hydroxypropyl cellulose (HPC), hydroxypropyl methylcellulose (HPMC) or carboxymethyl cellulose (CMC). Preferably, the cellulose derivatives are selected from hydroxypropyl methylcellulose (HPMC), carboxymethyl cellulose (CMC), cellulose acetate (CA), or a mixture thereof. More preferably, the cellulose derivatives selected are cellulose acetate or hydroxypropyl methylcellulose (HPMC). In a variant, it is possible to use a mixture of CA and HPMC.

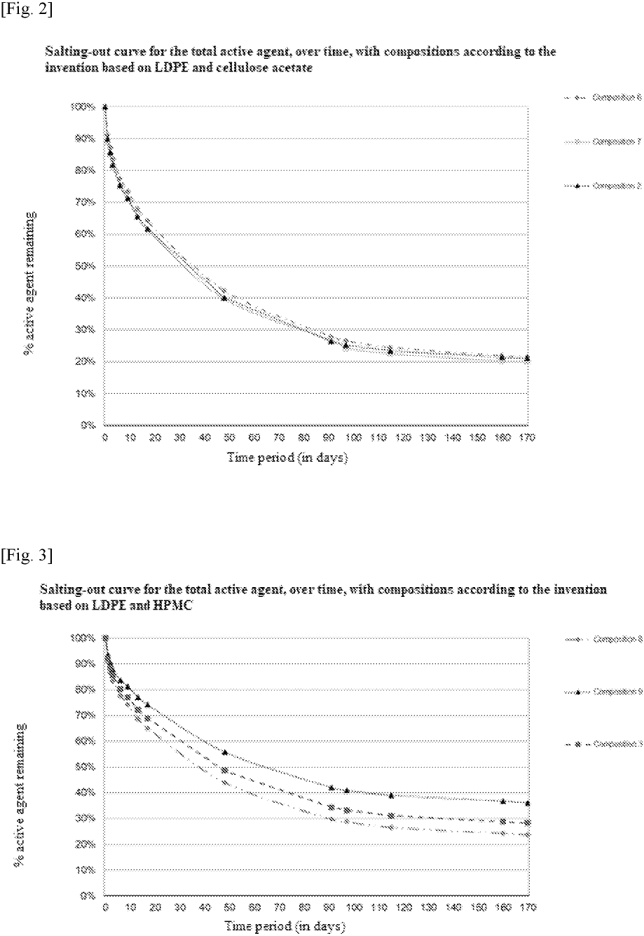

Various tests have been carried out, varying the type of the cellulose derivative and the concentration thereof at constant rates of active agent. Surprisingly, it has been observed that the cellulose derivative made it possible to promote the incorporation of the active agent(s) within the thermoplastic matrix. Furthermore, it has surprisingly been observed that the active agent release kinetics could be different depending on the type of the cellulose derivative and/or the concentration thereof and the type of the active agent(s). It has in particular been observed that the type of the cellulose derivative had an effect on the retention of certain active agents, which allows for modularity during the release thereof. The results showing these effects are set out in FIGS. 2 and 3. According to these curves, for the mixture of the active agents tested, the higher the rate of HPMC present in the formula, the more the active agent is retained within the matrix. For this mixture of active agents, the release kinetics thereof is different in the presence of HPMC or cellulose acetate. According to the present invention, it is therefore permitted to adjust the type and the proportion of cellulose derivatives to the result to be achieved, with regard to the release of the selected active agent(s).

For mechanical reasons, and in order to have a final product that is satisfactory in terms of flexibility, resistance, incorporation effectiveness, and stabilization of the active agent, the cellulose derivative represents between 5 wt.% and 40 wt.% of the total weight of the composite matrix, preferably between 10% and 25% of said matrix.

The problems of hold of extruded or injected materials are frequent, and all the more in the case of plastics composite materials. Conventionally, the hold at temperature, the mechanical resistance, the tendency to adhesion, or indeed the cracks under stress are factors. The applicant has tested the introduction of other polysaccharides than the cellulose derivatives. These comparative compositions have made it possible to introduce a similar percentage of active agents, but have been found to be unstable and/or not to lead to release of active agents, and/or to have physical characteristics which do not allow injection in order to obtain a finished product according to the invention. Unexpectedly, by the selection of the type and concentrations of cellulose derivative, the applicant makes it possible to avoid the problems cited above when obtaining the final product, after injection-molding or even extrusion.

In one embodiment, the cellulose derivative and the thermoplastic are in the form of granules, or in the form of powder, and can be used interchangeably in a mixture, in one form or another. Preferably, the cellulose derivative and the thermoplastic are used in the form of a powder.

Indeed, in the methods for producing a plastics solid matrix, the starting thermoplastic polymer is placed, in the form of granules, while the cellulose derivative is often in the form of powder, in a hopper, in order to then be mixed and heated until homogenization is achieved. However, on account of their form differences, the mixture between the polymer and the cellulose derivative often leads to demixing phenomena and losses of materials by adhesion to the wall, and the first lots are not necessarily homogeneous. Surprisingly, the applicant has been able to overcome these problems by selecting starting materials in the form of powder. Advantageously, this selection prevents demixing both in the incorporation mixer and in the hopper of the injection-molding press or the extruder. Improved homogenization of the powder mixture provides the final product with improved stability.

Preferably, in order to ensure optimal homogeneity of the mixture between the cellulose derivative and the thermoplastic polymer, the applicant has opted for a material in the form of powder, the average grain size of which is between 200 and 1000 µm. Preferably, the powders have an average grain size in the region of from 300 µm to 800 µm.

According to the invention, the composite matrix comprises at least one active agent representing between 2 and 40 wt.%, preferably between 4 and 35 wt.%, more preferably between 5 and 15 wt.% of the total weight of the matrix. The present invention thus makes it possible to incorporate a rate of active agents that is greater than the rate conventionally encountered in the prior art, in particular more than 2 wt.%, preferably more than 5 wt.% of the total weight, into a thermoplastic, and in particular PE, matrix.

According to the present invention, the active agent is an active agent of natural or synthetic origin, selected from cosmetics, biocides, medicines, phytosanitary agents, biocontrol agents, or a mixture thereof. According to a preferred embodiment, the active agent according to the invention may be an insecticide, a repellant, a microbicide, an attractant, an essential oil, a plant extract, an odiferous agent, an antistress agent, a soothing agent, an anti-irritant agent, a cosmetic agent, an anti-itching agent, a painkiller, or the mixtures thereof.

The insecticides and repellants of the present invention are known to a person skilled in the art; they are typically used in the control of harmful organisms. For example, the insecticides and the repellants are selected in particular from the group formed by the pyrethroids, the pyrethrins and the derivatives thereof, the carbamates, the formamidines, the carboxylic esters, N,N-diethyl-3-methylbenzamide (DEET), Icar-idin, IR3535, the phenylpyrazoles, the organophosphate compounds, the organohalo-genated compounds, the neonicotinoids, the avermectins and the derivatives thereof, the spinosyns, the essential oils and their constituents (examples: the terpenes and the derivatives thereof (alcohols, esters, aldehydes), the sesquiterpenes and the derivatives thereof (alcohols, esters, aldehydes)). In a variant according to the invention, the insecticides are selected from imidacloprid, deltamethrin, flumethrin, dimpylate, permethrin, cypermethrin, fipronil, diazinon, amitraz, n-octyl bicycloheptene dicarboximide, or indeed a mixture thereof.

In a preferred variant, the active agent is a repellant or an insecticide which is selected from the essential oils such as lavandin essential oil, geraniol, pyrethrum, lemon eucalyptus essential oil, citronella, lavender, neem, thyme, peppermint, spearmint, pennyroyal, wintergreen, or basil, alone or in a mixture, as well as any active agent belonging to the European biocide list or recognized by the United States Environmental Protection Agency (EPA 25b), which are well known to a person skilled in the art. Surprisingly, the applicant has noticed that the use of cellulose derivatives made it possible to preserve the heat-sensitive active agents, such as the essential oils, during the method of manufacturing a matrix of this kind.

According to a variant of the invention, the repellants are selected from the constituents of essential oils such as geraniol, lavandin, pyrethrum, limonene, menthol, thymol, alpha pinene, linalool, citriodiol, citronellal, or a mixture thereof.

The odiferous agent may be of natural or of synthetic origin and is selected from the perfumes, the fragrances, the essential oils, and the constituents thereof.

The antistress or soothing agent may be a vegetable oil such as sweet almond oil or hemp oil, in particular rich in cannabinoids, or an essential oil such as essential oil of valerian, nepeta cataria, pine, mandarin, bitter orange, verbena, ravintsara, chamomile, lavender, marjoram, ylang-ylang, rosemary, eucalyptus, or mint, or a pheromone.

The painkiller may be an essential oil or a component of the essential oils, monoterpenic alcohols, monoterpenic aldehydes, monoterpenic esters, or the mixtures thereof. By way of non-limiting examples, the painkillers may be peppermint essential oil, lemon Eucalyptus essential oil, wintergreen essential oil, rosemary essential oil, menthol, hemp derivatives such as cannabidiol (CBD), or indeed methyl salicylate.

The anti-itching agent may be an essential oil such as lavandin, lavender, peppermint essential oil, lemon Eucalyptus essential oil, or thyme essential oil, a vegetable oil such as argan oil, canola oil or borage vegetable oil, a fatty alcohol, an ester, a fatty acid and the esters thereof such as Omegas 3, 6 and 9, vitamins such as vitamin PP, B3, or the mixtures thereof.

In a preferred embodiment, the composite matrix according to the invention comprises active agents in the form of a mixture of essential oil or components of essential oil. A mixture that is particularly preferred according to the invention is made up of peppermint, thyme, geraniol essential oil. A second mixture of active agents that is preferred according to the invention comprises cedar and peppermint essential oil. Another alternative is a mixture of wintergreen and geraniol essential oil. Optionally, sweet almond oil may be added to each of said mixtures.

Since the active agents that are preferred according to the invention are in liquid form or are made liquid, they are associated with an additional difficulty of incorporation into the thermoplastic matrices, which accordingly justifies the need to improve the incorporation thereof and the stability thereof within said matrix, and, surprisingly, by virtue of the use of cellulose derivatives.

Additives could be used, in particular solvents, pro penetrants, antioxidants, and any other additive which a person skilled in the art considered useful to add in order to achieve the desired effect. According to the present invention, the matrix in particular comprises a mold release agent. The mold release agent is a fatty acid metal salt selected from zinc stearate, sodium stearate, or magnesium stearate, which are conventionally used by a person skilled in the art.

A second object of the invention is a method for manufacturing a solid composite matrix as described above.

In the field of plastics manufacturing, conventionally two main methods are known for manufacturing plastics items. These are, on the one hand, injection-molding, rotational molding and thermopressing methods, and, on the other hand, extrusion methods.

The prior art shows that the plastics materials referred to as “active,” and in particular PE, are produced in a conventional manner, by means of a twin-screw extrusion process. These twin-screw extrusion methods make it possible to mix the polymer and the active agents. A step of extrusion of the material or injection of the compound makes it possible to obtain the final form desired. Thus, the extrusion will be favored, in order to obtain a final product in the form of films, strips, tubes, or active wires. An injection method will be used to preferably obtain products in particular in the form of collars or straps.

“Active” plastic material means known plastics materials in which active materials have been incorporated, which may be of different types and may have different effects, as desired by a person skilled in the art.

Although often used, these methods are not entirely satisfactory with regard to the manufacture of “active” plastics materials. Indeed, the step of twin-screw extrusion remains limiting, in the sense that the temperatures used are over 200° C., and that the twin-screw system brings about very significant shearing on the material. Consequently, these methods tend to result in significant losses of active agents, on account of the restrictions mentioned above.

By way of the present application, the applicant overcomes the limitations mentioned, by proposing an injection-molding or extrusion method which allows for improved incorporation of fragile and heat-sensitive active agents, and improved preservation thereof. The injection-molding method is preferably used. It in particular offers more possibilities in the area of the forms which are desirable to obtain, for the final product.

The method developed by the applicant surprisingly makes it possible to incorporate, within plastics materials, even fragile and heat-sensitive active agents, by virtue of the prior incorporation of said active agents in powder or granules formed by at least one cellulose derivative. This incorporation is found to be particularly effective for PE, but remains appliable for the other thermoplastics known to a person skilled in the art. Thus, the cellulose derivative acts as a real carrier of active agents, the present invention achieves the advantage of obtaining a compound which is ready to be injected at the end of the method, without said compound being crushed or previously dissolved. Thus, the method according to the invention not only makes it possible to limit the losses of active agents, but it contributes to preserving the active agents within said matrix, without a step of crushing after incorporation. Moreover, said method makes it possible not to weaken the polymer network following a step of evaporation by means of a solvent. The method according to the invention will be described in the following.

In a first step of the method according to the invention, at least one cellulose derivative and at least one active agent are mixed until a homogeneous mixture is obtained. According to the present invention, “homogeneous” means a mixture within which the active agent has been entirely absorbed by the cellulose derivative.

This first step of the method consists in obtaining a “premix.” A “premix” means the composition obtained at the end of said first step of the method, consisting in incorporating a liquid solution of active agents in a powder or granules of a cellulose derivative as described above (cellulose acetate, HPMC, CMC). The cellulose derivative of the invention, in the form of powder or granules, thus plays a real vector role. A person skilled in the art will adjust the incorporation temperatures to the type of cellulose derivative, and to those of the active agents to be incorporated. In a particular embodiment, the incorporation with cellulose acetate is preferably carried out at ambient temperature. In another particular embodiment, the incorporation with HPMC is preferably carried out at a temperature which may reach 45° C. According to the invention, “ambient temperature” means a temperature of between 20 and 25° C.

In a second step, the premix obtained, and the thermoplastic, are mixed in order to obtain the composite matrix according to the invention, laden with active agents to be diffused. The matrix laden with active agent is also referred to as a compound, by a person skilled in the art. Said compound is then preferably subjected to an injection press or an extruder, in order to obtain an “active” composite matrix of the form desired. In a particular embodiment according to the invention, the injection/molding temperatures for obtaining matrices according to the invention, in the form of a collar or others are between 100 and 160° C.

Unexpectedly, the method according to the invention makes it possible to obtain stable composite polymer matrix compositions. Indeed, the method makes it possible to make the cellulose derivative, containing at least one active agent, compatible with different thermoplastics, in order to allow for the release of the active agent by the final product.

In a preferred variant, the thermoplastic used in the method is polyethylene (PE), preferably low-density polyethylene (LDPE).

During methods for manufacturing a plastics matrix, it is known to have to add plasticizing agents in order to achieve the desired mechanical resistance, or compatibilizing agents which help with the incorporation of the active agents in the matrix. Some of these agents make it possible to improve the incorporation of the active agents, but have the disadvantage of not facilitating the release of said active agents during use, or of not incorporating the active agents in a stable manner, which active agents thus exude, providing the obtained mixture with a sticky and/or oily structure which is not suitable for the injection-molding of the final product. Furthermore, these agents, which are well known to a person skilled in the art, are in particular phthalates, which have a proven toxicity, and are thus to be avoided. “Release” means the discharge of active agents by the matrix, in order that they are brought into contact with the target zones of the active agent. In the application, the terms “release” and “discharge” of the active agent(s) are used indifferently.

Advantageously and surprisingly, the method according to the invention makes it possible to incorporate active materials, which are in particular liquids or made liquid, into a cellulose derivative, which thus contributes to limiting the losses of active agents during the manufacturing method. The incorporation makes it possible to incorporate an amount of more than 2% into a polymer such as in particular PE, the PLAs, the polyesters, or the PVCs. The method furthermore makes it possible to maintain the stability of the whole, while eliminating the compatibilizing agent.

The object of the invention is therefore also a method for manufacturing a composite matrix as described above, and in particular in the preferred case of active agents which are liquid or made liquid, and which are to be incorporated into the matrix.

The method for manufacturing an active composite polymer matrix of this kind, according to the invention, comprises the following steps:
a) introducing active agent(s) into a suitable receptacle of the beaker type. In the case of a plurality of active agents, mixing the liquid active agents until they are homogenized,
b) introducing the cellulose derivative into a reactor. Heating to a temperature of between ambient temperature and 50° C., said temperature being defined by the type of the active agent(s) and of the cellulose derivative, and stirring,
c) progressively adding, in the reactor, the active agent mixture obtained in a), while stirring vigorously,
d) once the compound is dry, i.e. when the active agent or the mixture of active agents is entirely incorporated into the powder in a homogeneous manner, optionally adding a mold release agent and stirring to achieve homogenization,
e) cooling in the case of a mixture that was initially heated in order to reach ambient temperature, while stirring gently,
f) adding the thermoplastic, and homogenizing, while stirring vigorously,
g) emptying.

By way of non-limiting example, “gentle stirring” according to the invention means stirring corresponding to a stirring speed of approximately 40 rpm. “Vigorous stirring” means a stirring speed of between 200 and 400 rpm, performed using a reactor of the laboratory type, and which may reach 600 rpm using a pilot reactor of 8 liters. A person skilled in the art will be capable of adjusting the stirring speeds depending on the type and the size of the reactor, as well as the mixtures to be stirred.

Thus, the control of the heating and cooling stages, the stirring speed, as well as the management of the speed of adding the active agents are the parameters which make it possible to ensure that the product obtained is homogeneous and preferably in the form of an active powder which is deagglomerated and stable. This method moreover makes it possible to obtain active powders at relatively low temperatures, in order to ensure the conversion of the most sensitive active substances.

This method surprisingly makes it possible to obtain a solid composite matrix which incorporates at least 5 wt.% active agent compared with the total weight of the matrix.

In a preferred variant, said method is applied to low-density polyethylene, biodegradable polyester, PLA, TPU, or indeed PVC, notwithstanding the other thermoplastics cited in the present application, which may also be used.

The invention relates to a variant of the method according to the invention which consists, depending on the type of the active agents and of the thermoplastic used, in incorporating some of the active agents in advance, into the thermoplastic.

The invention also relates to a second variant of the method, which consists in directly incorporating the active agent(s) into the mixture, previously formed, of the thermoplastic and the cellulose derivative(s).

A person skilled in the art will adjust the method to the type of thermoplastic, and to that of the active agents to be incorporated therein.

In a preferred embodiment, the step of incorporation a) is performed on cellulose acetate, at ambient temperature. In a second preferred embodiment, the incorporation is performed on HPMC at a temperature of 45° C. The incorporation temperatures of the cellulose derivative, according to the invention, are carried out at temperatures below the temperatures that risk degrading the active agents, such as the essential oils.

The product obtained at the end of the method is then introduced into an injection press or an extruder, in order to mold it to the shape and size desired. The method according to the invention also has the advantage of obtaining a compound which can be directly injected, once the polymer/premix mixture is made. This method avoids a crushing step, which may result in a loss of active agent or problems during the injection. According to the present invention, the device is molded in the form of films, strips, tubes or strands, or in the form of a collar, a tag, an animal ear tag, a strap, a patch, a pad, a block polymer, a harness, a strip, a belt, or any other form suitable for the use and for the subject, for external use. Preferably, the matrix according to the invention is formed as collars.

The invention also relates to the use of the composite matrix according to the invention, preferably for conveying active agents in order to improve the wellbeing of animals, and more particularly in terms of pain relief, muscular comfort, improvement of stress, or by way of a repellent effect against pests or indeed insecticides. A person skilled in the art will adjust the selection of the active agents used, in order to achieve the desired effect.

The present invention also relates to the use of at least one cellulose derivative as active agent vectors for improving the incorporation of active agents in a thermoplastic matrix. “Improving the incorporation of active agent” means the possibility of incorporating a quantity of active agents that is greater than that encountered in the prior art, i.e. a quantity of active agent of more than 2 wt.%, preferably between 4 and 35 wt.%, of the total weight of said matrix. “Improving the incorporation of active agents” also means obtaining an active agent which is stable in the matrix. “Active agent which is stable in the matrix” means an active agent which does not ooze, but which is progressively released over the course of the use of the matrix. According to the present invention, the selection of the type of the cellulose derivative, and the quantity thereof, will make it possible to influence the release of the active agent over time.

The present invention relates to a composite matrix comprising at least one thermoplastic polymer, at least one cellulose derivative, characterized in that said cellulose derivative is laden with at least one active agent and represents between 5 and 40 wt.% of the total weight of said matrix. Said cellulose derivative preferably represents between 10 and 25 wt.% of the total weight of said matrix. Said cellulose derivative has an active agent vector role.

The matrix according to the invention is characterized in that the cellulose derivative is selected from the cellulose esters, the cellulose ethers, or a mixture thereof, and preferably from cellulose acetate, carboxymethylcellulose, hydroxypropyl methylcellulose, or a mixture thereof.

The matrix according to the invention is characterized in that the active agent represents between 4 and 35 wt.% of the total weight of said matrix, and is preferably selected from the essential oils, or their components alone or in a mixture.

The invention relates to a matrix which is characterized in that the thermoplastic polymer is selected from the polyethylenes (PE), the polylactic acids (PLA), the thermoplastic polyurethanes (TPU), the polyvinyl chlorides (PVC), or the polyesters.

The invention relates to a matrix which is characterized in that the thermoplastic polymer is a polyethylene, preferably a low-density polyethylene, and that it is present in a sufficient quantity for reaching 100 wt.% of the total weight of the matrix.

The invention relates to the matrix which is characterized in that it is present in the form of a collar, straps, harness, strip or belt.

The invention relates to a matrix which is characterized in that the plastics polymer and cellulose derivative mixture is a powder mixture, preferably having an average grain size of between 200 and 1000 µm.

The invention also relates to a method for manufacturing a matrix as described above, comprising the following steps:
a) forming the mixture of the active agent(s) with the cellulose derivative, in powder form, until the active agent(s) is/are entirely incorporated within said cellulose derivative.
b) adding powdered thermoplastic to the mixture obtained in a)
c) injecting the obtained matrix into a molding or extrusion press

More particularly, the method according to the invention is as follows:
a) mixing liquid active agents,
b) introducing the cellulose derivative into a reactor, and heating to a temperature of between 20 and 50° C., while stirring,
c) progressively adding, in the reactor, the active agent mixture obtained in a) to the cellulose derivative prepared in b), while stirring vigorously,
d) cooling to an ambient temperature, while stirring gently,
e) adding the thermoplastic, and homogenizing, while stirring vigorously,
f) emptying.

The invention also relates to the preceding method, which is characterized in that it comprises a step of adding a mold release agent.

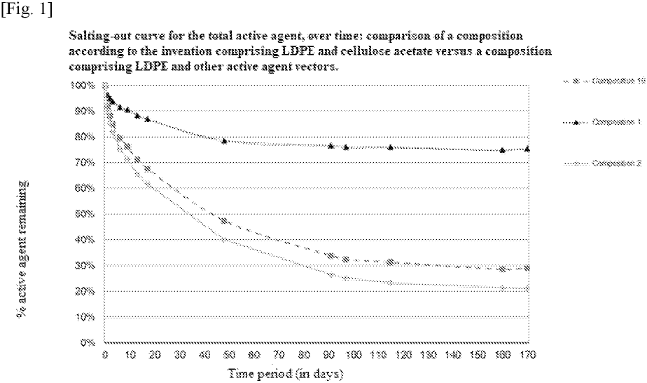

The present invention also relates to the use of at least one cellulose derivative for improving the incorporation of active agents in a thermoplastic matrix. The present invention also relates to the use of at least one cellulose derivative for improving the incorporation of at least one active agent in said matrix, characterized in that said cellulose derivative is selected from the cellulose esters, the cellulose ethers or a mixture thereof, and said active agent represents between 4 and 35 wt.% of the total weight of said matrix.

[FIG. 1] shows the results of the study of the influence of the type and of the concentration of the cellulose compound on the salting-out kinetics of the active agent. The release of the active agents is measured by gravimetry. The compositions tested are composition 2 according to the invention, described in example 2, compared with comparative compositions 1 and 10, described in examples 1 and 10, respectively. The curves show that:
composition 1 without cellulose derivative does not allow for release of the active agents over time, and is therefore not suitable for the intended aim of the compositions according to the invention.
composition 10 containing xanthan gum in the form of an active agent vector allows for incorporation and salting-out of the active agents over time, but this composition has been found not to be stable following degradation of the xanthan gum due to the temperature used during the production process,
only composition 2 according to the invention has been found to be stable, making it possible to incorporate the active agents at a percentage of over 5%, and then to release them in a regular manner, over time.

[FIG. 2] shows the results of the study of the influence of the concentration of the cellulose acetate on the release kinetics of the active agent within compositions 2, 6 and 7 according to the invention. The curves show that the release of the active agents is not proportional to the concentration of acetate used, and allows the three concentrations tested to effectively incorporate and release the active agents.

[FIG. 3] shows the results of the study of the influence of the concentration of HPMC on the release kinetics of the active agent within compositions 3, 8 and 9 according to the invention. The concentration of HPMC influences the quantity of active agents released, and makes it possible to modulate the release kinetics of the active agent depending on the effect sought.

### Example 1 Comparative: Composition 1 Without Cellulose Derivative

TABLE 1

| Composition 1 | Concentration (%) |
|---|---|
| Polyethylene (CAS 9002-88-4) | 93.86 |
| Geraniol | 0.49 |
| Peppermint essential oil | 2.37 |
| Thyme satureioides essential oil | 0.59 |
| Gylceryl dicaprylate | 2.69 |

This composition was prepared using the preferred active agents according to the invention, to be integrated into a polyethylene matrix, without adding cellulose derivative, in order to compare this with a composition according to the invention. A number of difficulties were encountered, and various formulation tests had to be carried out in order to manage to obtain a composition in which the active agents could be incorporated. At the end of the various tests, however, it was necessary to use an alternative vector, glyceryl dicaprylate, in order to stabilize the active agents in the LDPE matrix. Moreover, it has not been possible to incorporate, within a composition of this kind, more than 3.45% active agents to maintain a composition which is stable and injectable. However, the aim is to manage to incorporate at least 5% active agents. Moreover, the curve of FIG. 1 shows that the active agents are not released by said formula over time.

This composition is compared with examples 2 and 10, described below, and the release curves of the active agents over time are shown in FIG. 1.

Examples 2 to 9 described below are examples of stable compositions according to the invention, which describe compositions that cause the active agents to vary, as well as the cellulose derivative and the concentration thereof.

### Example 2: Composition 2 of LDPE Plus 10% Cellulose Acetate

TABLE 2

| Composition 2 | Concentration (%) |
|---|---|
| Polyethylene | 81.60 |
| Cellulose ester: cellulose acetate | 10.00 |
| Geraniol | 0.90 |
| Peppermint essential oil | 4.40 |
| Thyme satureioides essential oil | 1.10 |
| Zinc stearate | 2.00 |

By virtue of adding the vector cellulose acetate, it was possible to obtain a stable composition comprising 6.4% of the mixture of active agents that are preferred for a repellant composition according to the invention.

The method for preparing composition 2 is carried out according to the following steps:

Geraniol and the two essential oils are introduced into a beaker, at ambient temperature, i.e. 25° C. This is stirred gently using a magnetic bar, in order to obtain a homogeneous mixture which constitutes the solution of active agents.

The cellulose acetate is incorporated, at ambient temperature, while stirring vigorously. The stirring is continued as long as the mixture of active agents is not entirely incorporated into the cellulose acetate powder, and the compound does not appear dry, in order to obtain the “premix.”

Once the compound is dry, zinc stearate is added, while stirring. Subsequently, PE is added to the cellulose acetate/active agent “premix” obtained previously, in the mixer, while stirring vigorously. This is stirred until all the liquid is entirely absorbed by the polymer. The mixer is emptied, and the compound thus obtained is stored in packaging that is hermetically sealed with respect to air and humidity. The product obtained makes it possible to incorporate the active agents in a stable manner. FIG. 1 clearly shows that composition 2 according to the invention makes it possible to release the active agent, in contrast with composition 1 which does not make it possible to release the active agents, or composition 10 which is unstable.

The product thus obtained can then be introduced into an injection press in order to mold it to the shape and size obtained. In the present example, the powder laden with active agents is injected, in order to obtain a collar for a dog or cat which can be adjusted to different sizes, such as 35, 60 or 75 cm. Said collar is intended to be worn by a dog or a cat, around the neck, in order to ward off harmful parasites.

### Example 3: Composition 3 of LDPE Plus 10% HPMC

TABLE 3

| Composition 3 | Concentration (%) |
|---|---|
| Polyethylene | 81.60 |
| Cellulose ether: hydroxypropylmethyl cellulose (HPMC) | 10.00 |
| Geraniol | 0.90 |
| Peppermint essential oil | 4.40 |
| Thyme satureioides essential oil | 1.10 |
| Zinc stearate | 2.00 |

### Example 4: Composition 4 of LDPE Plus 30% Cellulose Acetate

TABLE 4

| Composition 4 | Concentration (%) |
|---|---|
| Polyethylene | 61.60 |
| Cellulose ester: cellulose acetate | 30.00 |
| Geraniol | 0.90 |
| Peppermint essential oil | 4.40 |
| Thyme satureioides essential oil | 1.10 |
| Zinc stearate | 2.00 |

### Example 5: Composition 5 of LDPE Plus 30% HPMC

TABLE 5

| Composition 5 | Concentration (%) |
|---|---|
| Polyethylene | 61.60 |
| Cellulose ether: HPMC | 30.00 |
| Geraniol | 0.90 |
| Peppermint essential oil | 4.40 |
| Thyme satureioides essential oil | 1.10 |
| Zinc stearate | 2.00 |

### Example 6: Composition 6 of LDPE Plus 5% Cellulose Acetate

TABLE 6

| Composition 6 | Concentration (%) |
|---|---|
| Polyethylene | 86.60 |
| Cellulose ester: cellulose acetate | 5.00 |
| Geraniol | 0.90 |
| Peppermint essential oil | 4.40 |
| Thyme satureioides essential oil | 1.10 |
| Zinc stearate | 2.00 |

### Example 7: Composition 7 of LDPE Plus 15% Cellulose Acetate

TABLE 7

| Composition 7 | Concentration (%) |
|---|---|
| Polyethylene | 76.60 |
| Cellulose ester: cellulose acetate | 15.00 |
| Geraniol | 0.90 |
| Peppermint essential oil | 4.40 |
| Thyme satureioides essential oil | 1.10 |
| Zinc stearate | 2.00 |

### Example 8: Composition 8 of LDPE Plus 5% HPMC

TABLE 8

| Composition 8 | Concentration (%) |
|---|---|
| Polyethylene | 86.60 |
| Cellulose ether: HPMC | 5.00 |
| Geraniol | 0.90 |
| Peppermint essential oil | 4.40 |
| Thyme satureioides essential oil | 1.10 |
| Zinc stearate | 2.00 |

### Example 9: Composition 9 of LDPE Plus 15% HPMC

TABLE 9

| Composition 9 | Concentration (%) |
|---|---|
| Polyethylene | 76.60 |
| Cellulose ether: HPMC | 15.00 |
| Geraniol | 0.90 |
| Peppermint essential oil | 4.40 |
| Thyme satureioides essential oil | 1.10 |
| Zinc stearate | 2.00 |

### Example 10: Composition 10 of LDPE Plus Other Polysaccharide

TABLE 10

| Composition 10 | Concentration (%) |
|---|---|
| Polyethylene | 81.60 |
| Polysaccharide: xanthan gum | 10.00 |
| Geraniol | 0.90 |
| Peppermint essential oil | 4.40 |
| Thyme satureioides essential oil | 1.10 |
| Zinc stearate | 2.00 |

Composition 10 was formed in order to test an alternative polysaccharide to cellulose derivatives, xanthan gum, as a vector of active agents of the composition. The curve of FIG. 1 shows that the active agents could be incorporated at 6.4%, and are salted-out over time. However, the composition is not stable, and cannot be injected. Degradation of the color and the odor is observed, on account of the degradation of the xanthan gum. A lower temperature would be necessary during the injection process in order for the xanthan gum not to degrade, but this temperature would not be sufficient for softening the PE and making the formula injectable. Composition 10 is therefore not in accordance with what the applicant wishes to obtain.

### Example 11: Composition 11 OF LDPE Plus 30% HPMC

TABLE 11

| Composition 11 | Concentration (%) |
|---|---|
| Polyethylene | 59.20 |
| Cellulose ether: HPMC | 30.00 |
| Peppermint essential oil | 4.40 |
| Cedar essential oil | 4.40 |
| Zinc stearate | 2.00 |

### Example 12: Composition 12 of LDPE Plus 35% HPMC

TABLE 12

| Composition 12 | Concentration (%) |
|---|---|
| Polyethylene | 54.20 |
| Cellulose ether: HPMC | 35.00 |
| Peppermint essential oil | 4.40 |
| Cedar essential oil | 4.40 |
| Zinc stearate | 2.00 |

### Example 13: Composition 13 of LDPE Plus 40% HPMC

TABLE 13

| Composition 13 | Concentration (%) |
|---|---|
| Polyethylene | 49.20 |
| Cellulose ether: HPMC | 40.00 |
| Peppermint essential oil | 4.40 |
| Cedar essential oil | 4.40 |
| Zinc stearate | 2.00 |

### Example 14: Composition 14 of LDPE Plus 40% Cellulose Acetate

TABLE 14

| Composition 14 | Concentration (%) |
|---|---|
| Polyethylene | 49.20 |
| Cellulose ester: cellulose acetate | 40.00 |
| Peppermint essential oil | 4.40 |
| Cedar essential oil | 4.40 |
| Zinc stearate | 2.00 |

### Example 15: Composition 15 OF PLA Plus 20% Cellulose Acetate

TABLE 15

| Composition 15 | Concentration (%) |
|---|---|
| PLA | 60 |
| Cellulose ester: cellulose acetate | 23.15 |
| Peppermint essential oil | 16.85 |

### Example 16: Shows 3 Compositions (16 TO 18) of Matrices Comprising Insecticide Active Agents and Cellulose Acetate According to the Invention

TABLE 16

| Composition 16 | Concentration (%) |
|---|---|
| PVC | 70 |
| Cellulose ester: cellulose acetate | 17.37 |
| Cypermethrine | 12.63 |

TABLE 17

| Composition 17 | Concentration (%) |
|---|---|
| TPU | 60 |
| Cellulose ester: cellulose acetate | 25 |
| n-octyl bicyclopehtene dicarboximide | 15 |

TABLE 18

| Composition 18 | Concentration (%) |
|---|---|
| PLA | 70 |
| Cellulose ester: cellulose acetate | 15 |
| Diazinon | 15 |

1. A composite matrix comprising at least one thermoplastic polymer and at least one cellulose derivative, wherein the cellulose derivative is loaded with at least one active ingredient and represents between 5 to 40% by total weight of said matrix.

2. The matrixaccording toclaim 1, wherein the cellulose derivative is chosen from cellulose esters, cellulose ethers or a mixture thereof.

3. The matrix according to claim 1, wherein the cellulose derivative is chosen from cellulose acetate, carboxymethylcellulose, hydroxypropylmethylcellulose or their mixture.

4. The matrix according to claim 3, wherein the active ingredient represents between 4 and 35% by total weight of the said matrix.

5. The matrix according to claim 1, wherein the active ingredient is an active ingredient of natural or synthetic origin chosen from insecticides, repellents, attractants or essential oils.

6. The matrixaccording to claim 1, wherein the thermoplastic polymer is chosen from polyethylenes (PE), polylactic acids (PLA), thermoplastic polyurethanes (TPU), polyvinyl chlorides (PVC) or Polyesters.

7. The matrix according to wherein the thermoplastic polymer is a low density polyethylene.

8. The matrixaccording to claim 1, wherein the thermoplastic polymer is present in an amount sufficient to reach 100% by total weight of the matrix.

9. The matrixaccording to claim 1, wherein the mixture of thermoplastic polymer and cellulose derivative is a mixture of powders.

10. The matrixaccording to claim 1, wherein the matrix is in the form of a necklace, bracelets, harness, strap or belt.

11. A processfor manufacturing a matrix according to claim 1 comprising:
a) mixing the at least one active ingredient with the cellulose derivative in powder form until the at least one active ingredient is fully incorporated into said cellulose derivative.
b) adding powdered thermoplastic to the mixture obtained in a); and
c) injecting the matrix obtained into a molding or extrusion press .

12. The process according to claim 11, further comprising adding a release agent.

13. A use of at least one cellulose derivative to improve the incorporation of active agents within a thermoplastic matrix according to claim 1 .

14. The use according to claim 13, wherein the cellulose derivative is chosen from cellulose esters, cellulose ethers or a mixture thereof.

15. The useaccording to claim 13, wherein the active ingredient represents between 4 and 35% by total weight of the matrix.

16. The matrix according to claim 4, wherein the active ingredient is an active ingredient of natural or synthetic origin chosen from insecticides, repellents, attractants or essential oils.

17. The matrix according to claim 5, wherein the thermoplastic polymer is chosen from polyethylenes (PE), polylactic acids (PLA), thermoplastic polyurethanes (TPU), polyvinyl chlorides (PVC) or Polyesters.

18. The matrix according to claim 17, wherein the thermoplastic polymer is a low density polyethylene.

19. The matrix according to claim 16, wherein the matrix is in the form of a necklace, bracelets, harness, strap or belt.

20. The matrix according to claim 17, wherein the matrix is in the form of a necklace, bracelets, harness, strap or belt.
